(19) United States
(12) Patent Application Publication
(10) Pub. No.: US 2025/0235935 A1
(43) Pub. Date: Jul. 24, 2025

(54) Chuck with Magnetic Jaw and Methods of Using the Same

(71) Applicant: Vishaal Verma, Crystal Lake, IL (US)

(72) Inventor: Vishaal Verma, Crystal Lake, IL (US)

(21) Appl. No.: 19/036,810

(22) Filed: Jan. 24, 2025

Related U.S. Application Data
(60) Provisional application No. 63/624,645, filed on Jan. 24, 2024.

(51) Int. Cl. B23B 31/28

(52) U.S. Cl. CPC B23B 31/28

(57) ABSTRACT

A drill has an improved drill chuck, wherein at least one of the drill chuck's jaws comprises a magnet or is otherwise magnetic so as to hold a drill bit in an orientation to ensure that the chuck jaws close properly around the drill bit, without jamming or otherwise misaligning within the drill chuck. A method of using the same is further provided.

### CROSS-REFERENCE TO RELATED APPLICATIONS

The present invention claims priority to U.S. Prov. Pat. App. App. No. 63/624,645, titled “Drill Chuck With Magnetic Jaw,” filed Jan. 24, 2024, which is incorporated herein by reference in its entirety.

### TECHNICAL FIELD

The present invention comprises a chuck jaw having a magnet or is otherwise magnetic so as to hold a bit or shaft of a tool or driver accessory in an orientation to ensure that the chuck jaws of a chuck close properly around the bit, tool accessory, or other accessory, without jamming or otherwise misaligning within the chuck. A method of using the same is further provided.

### BACKGROUND

Electric drills, drivers, presses, lathes, and other tools or machines are well-known and typically have a three-jaw chuck for closing on a bit or other driver accessory for holding the bit, tool accessory, or other accessory in alignment for use. A user opens the chuck by spinning an annular element by hand or using a chuck key. As the annular element spins, the jaws within the chuck extend or retract, depending on the direction of rotation of the annular element, and either close on or open up from a center space. The shaft of the bit, tool or other accessory typically sits within the central space until the jaws of the chuck close thereupon, holding the bit or other driver accessory in position for use. For example, a chuck is well-known as part of an electric drill for holding drill bits or other like accessories therein.

In use, the bit, tool or other accessory extends from the central space between the jaws of the chuck. However, if the shaft of the bit, tool accessory, or other accessory is misaligned within the central space, then the shaft or shank of the bit, tool accessory or other accessory may become jammed between the jaws, as illustrated in FIGS. 1 and 2, showing a drill bit 10 misaligned within a drill chuck 12 having three extendible and retractable jaws 14a, 14b, 14c. Because the shaft or shank of the drill bit 10 is misaligned, upon closing the jaws by extending the same, the drill bit 10 is jammed between jaws 14a, 14b and is unable to be used properly. Indeed, one could not use such a configuration for drilling a desired hole in a substrate. Moreover, a drill bit may extend through a center space but may not be aligned concentrically within the center space, causing bit wobble.

A need, therefore, exists for an improved tool or machine having a chuck, such as, for example, a drill having a drill chuck. Specifically, a need exists for an improved chuck for a tool or machine that easily aligns bits, tool accessories, and/or other accessories properly within the chuck. More specifically, a need exists for an improved chuck for a tool or machine that consistently provides for proper alignment of the bit, tool accessory and/or other accessories.

Moreover, a need exists for an improved chuck for a tool or machine that utilizes magnetism to hold a shaft of a bit, tool accessory, or other accessory. Specifically, a need exists for an improved chuck for a tool or machine that magnetically holds the shaft of the bit, tool accessory, or other accessory in a proper alignment when the jaws of the chuck are in a retracted or open configuration. Likewise, a need exists for an improved chuck for a drill that magnetically holds the shaft of the bit, tool accessory, or other accessory in the proper alignment as the jaws extend or close upon the shaft of the bit or other accessory.

### SUMMARY OF THE INVENTION

The present invention comprises a chuck jaw having a magnet or is otherwise magnetic so as to hold a bit, tool accessory or shaft of any like accessory in an orientation to ensure that the chuck jaws of a chuck close properly around the bit, tool accessory, or other like accessory, without jamming or otherwise misaligning within the chuck. A method of using the same is further provided.

To this end, in an embodiment of the present invention, a chuck jaw is provided. The chuck jaw comprises: a body; a mount surface on the body configured to engage a shaft of a metal object; and a first magnet disposed on or within the body, wherein the first magnet is configured to hold the shaft of the metal object on and in alignment with the mount surface when the shaft of the metal object is inserted into a top of a chuck comprising the chuck jaw.

In an embodiment, the mount surface of the body has a shape selected from the group consisting of concave and flat.

In an embodiment, the body of the chuck jaw comprises a first cavity, wherein the first magnet is disposed within the cavity.

In an embodiment, the chuck jaw is configured to be disposed within a chuck of a tool or machine with a plurality of other chuck jaws for holding the shaft of the metal object therein.

In an embodiment, the magnet has a shape selected from the group consisting of a sphere, a cylinder, a cube, and a rectangular prism.

In an embodiment, the magnet is disposed within the body at or near the mount surface.

In an embodiment, the magnet is disposed a distance from a top edge of the chuck jaw.

In an embodiment, the chuck jaw further comprises: a second magnet embedded within the body.

In an embodiment, the second magnet is disposed within the body at or near the mount surface.

In an embodiment, the first magnet is disposed at a first location at or near the mount surface and the second magnet is disposed at a second location at or near the mount surface, wherein the first location and the second location are spaced a distance apart.

In an embodiment, the first magnet is a permanent magnet or an induced magnet.

In an embodiment, the first magnet is a neodymium magnet.

In an embodiment, the mount surface comprises the first magnet.

In an embodiment, the chuck jaw further comprises: a pad or insert forming the mount surface of the body.

In an embodiment, the first magnet is embedded on or within the pad or insert forming the mount surface of the body.

In an embodiment, the magnet or magnets are held on or within the body of the chuck jaw via a method selected from the group consisting of adhesive bonding, welding, potting, and plastic overmolding.

In an embodiment, a tool or machine comprises the chuck jaw as described herein.

In an embodiment, the tool or machine comprises a chuck comprising a second chuck jaw and a third chuck jaw.

In an alternate embodiment, a method of inserting a shaft of an object into a chuck is provided. The method comprises the steps of: providing a tool or machine comprising a chuck comprising a plurality of chuck jaws, wherein the plurality of chuck jaws extend or retract to hold or release, respectively, the shaft of the object, wherein a first chuck jaw comprises a body, a mount surface on the body configured to engage a shaft of a metal object, and a first magnet disposed on or within the body, wherein the first magnet is configured to hold the shaft of the object on the mount surface; inserting the shaft of the object into the chuck so that the first magnet within the first chuck jaw magnetically holds the shaft of the object along the mount surface on the body of the first chuck jaw; and extending the plurality of chuck jaws to close the plurality of chuck jaws on the shaft of the object.

In an embodiment, the first chuck jaw further comprises a second magnet disposed on or within the body of the first chuck jaw.

In an embodiment, the first magnet is disposed at a first location at or near the mount surface and the second magnet is disposed at a second location at or near the mount surface, wherein the first location and the second location are spaced a distance apart.

It is, therefore, an advantage and objective of the present invention to provide an improved tool or machine, such as, for example, an improved drill and drill chuck.

Specifically, it is an advantage and objective of the present invention to provide an improved chuck for a tool or machine that easily aligns bits, tool accessories, and/or other like accessories properly within the chuck.

More specifically, it is an advantage and objective of the present invention to provide an improved chuck for a tool or machine that consistently provides for proper alignment of the bit, tool accessory, and/or other accessories.

Moreover, it is an advantage and objective of the present invention to provide an improved chuck for a tool or machine that utilizes magnetism to hold a shaft of a bit, tool accessory, or other accessory.

Specifically, it is an advantage and objective of the present invention to provide an improved chuck for a tool or machine that magnetically holds the shaft of the bit, tool accessory, or other driver accessory in a proper alignment when the jaws of the chuck are in a retracted or open configuration.

Likewise, it is an advantage and objective of the present invention to provide improved chuck for a tool or machine that magnetically holds the shaft of the bit, tool accessory, or other accessory in the proper alignment as the jaws extend or close upon the shaft of the bit, tool accessory, or other accessory.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art top view of a drill chuck having a plurality of jaws with a drill bit jammed between two of the jaws.

FIG. 2 illustrates a top perspective view of a drill chuck having a plurality of jaws with a drill bit jammed between two of the jaws.

FIG. 3 illustrates a top perspective view of a drill chuck having a plurality of jaws, with one of the jaws having an embedded magnet therein, in an embodiment of the present invention.

FIG. 4 illustrates a top perspective view of a drill chuck having a plurality of jaws, with one of the jaws having first and second magnets embedded therein, in an embodiment of the present invention.

FIG. 5 illustrates a top view of a drill chuck having a plurality of jaws, with a drill bit aligned against a longitudinal groove within one of the jaws, in an embodiment of the present invention.

FIG. 6 illustrates a top perspective view of a drill chuck having a plurality of jaws, with a drill bit aligned against a longitudinal groove within one of the jaws, in an embodiment of the present invention.

FIG. 7 illustrates a cross-sectional view of a drill chuck along line VII-VII, the drill chuck having a plurality of jaws, with one of the jaws having first and second magnets embedded therein.

FIG. 8 illustrates a perspective view of a drill chuck jaw having magnets embedded therein in an embodiment of the present invention.

FIG. 9 illustrates a front view of a drill chuck jaw having magnets embedded therein in an embodiment of the present invention.

FIG. 10 illustrates a cross-sectional view along line X-X of FIG. 9 of a drill chuck jaw having magnets embedded therein in an embodiment of the present invention.

FIG. 11 illustrates a cross-sectional view along line XI-XI of FIG. 9 of a drill chuck jaw showing an embedded magnet therein in an embodiment of the present invention.

FIGS. 12A-12B illustrate a side view and a front view of a drill chuck jaw having magnets embedded therein with a drill bit held magnetically thereon in an embodiment of the present invention.

FIG. 13 illustrates a cross sectional view along line XIII-XIII of FIG. 12B of a drill chuck jaw showing an embedded magnet and a drill bit held magnetically thereon in an embodiment of the present invention.

FIG. 14 illustrates a front view of a drill chuck jaw having embedded magnets therein in an alternate embodiment of the present invention.

FIG. 15 illustrates a cross-sectional view along line XV-XV of FIG. 14 of a drill chuck jaw showing magnets embedded therein in an alternate embodiment of the present invention.

FIG. 16 illustrates a front view of a drill chuck jaw having an embedded magnet therein in an alternate embodiment of the present invention.

FIG. 17 illustrates a cross-sectional view along line XVII-XVII of FIG. 16 of a drill chuck jaw showing a magnet embedded therein in an alternate embodiment of the present invention.

FIG. 18 illustrates a front view of a drill chuck jaw having a magnet disposed thereon in an alternate embodiment of the present invention.

FIG. 19 illustrates a cross-sectional view along line XIX-XIX of FIG. 18 of a drill chuck jaw showing a magnet disposed thereon in an alternate embodiment of the present invention.

FIG. 20 illustrates a cross sectional view along line XX-XX of FIG. 18 of a drill chuck jaw showing a magnet disposed thereon in an alternate embodiment of the present invention.

FIG. 21 illustrates a front view of a drill chuck jaw having a magnet disposed therein in an alternate embodiment of the present invention.

FIG. 22 illustrates a cross-sectional view along line XXII-XXII of FIG. 21 of a drill chuck jaw showing a magnet disposed therein in an alternate embodiment of the present invention.

FIG. 23 illustrates a cross sectional view along line XXIII-XXIII of FIG. 21 of a drill chuck jaw showing a magnet disposed therein in an alternate embodiment of the present invention.

FIG. 24 illustrates a front view of a drill chuck jaw having a magnet disposed therein in an alternate embodiment of the present invention.

FIG. 25 illustrates a cross-sectional view along line XXV-XXV of FIG. 24 of a drill chuck jaw showing a magnet disposed therein in an alternate embodiment of the present invention.

FIG. 26 illustrates a cross sectional view along line XXVI-XXVI of FIG. 24 of a drill chuck jaw showing a magnet disposed therein in an alternate embodiment of the present invention.

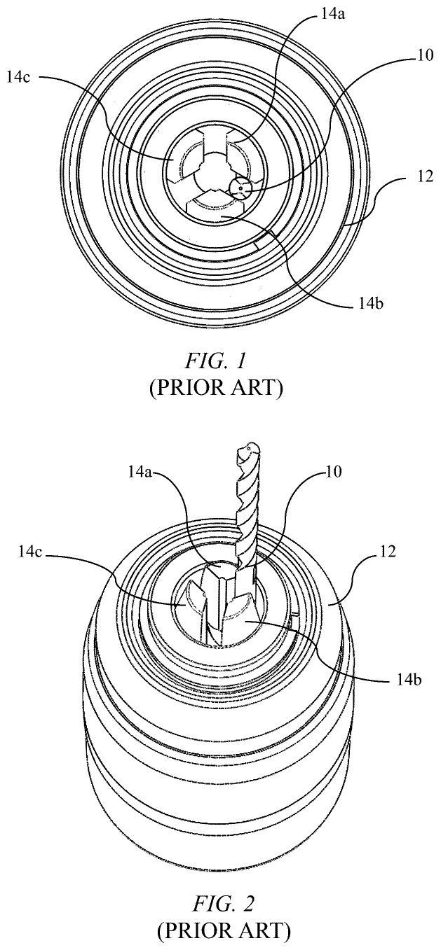

### DETAILED DESCRIPTION OF THE PRESENTLY PREFERRED EMBODIMENTS

The present invention comprises a chuck jaw having a magnet or is otherwise magnetic so as to hold a bit, tool accessory, or shaft of any other like accessory in an orientation to ensure that the chuck jaws of a chuck close properly around the bit, tool accessory, or other like accessory without jamming or otherwise misaligning within the chuck. A method of using the same is further provided.

Now referring to the figures, wherein like numerals refer to like parts, FIG. 3 illustrates a drill chuck 20, which would normally extend from a front of a drill, a driver, a lathe, a mill, a press, or other like tool, machine, or device. Although the present invention utilizes the term “drill chuck” herein, it should be noted that use of the term “drill chuck” is meant to include any tool or machine that utilizes jaws within a chuck in the manner described herein to clamp down on a shank or shaft of a tool, such as a drill bit or other like tool accessories (herein referred to as a “metal object”). As noted above, this may include a chuck for any driver or press, lathe, mill, or any other like tool or machine.

The drill chuck 20 is configured to engage a shaft of a drill bit or other driver accessory as is known to one of ordinary skill in the art. Typically, the shafts of drill bits and/or other driver accessories is made from a metal, typically steel or other metal that is attracted to a magnet when disposed in proximity thereto. Although the drill chuck may be oriented in any configuration, end 21 is preferably referred to herein as the “top” of the drill chuck, typically where a drill bit or other driver accessory may be inserted and held therein.

Within the drill chuck 20 may be a plurality of drill chuck jaws, 22a, 22b, 22c. Typically, a drill chuck, as shown in FIG. 3, comprises three drill chuck jaws, but it should be noted that the drill chuck may contain any number of jaws and should not be limited as described herein. The drill chuck jaws 22a-22c typically extend and retract, depending on the rotation of an annular element either by hand, by a key, or via other method. As the annular element rotates, the drill chuck jaws 22a-22c may extend outward from the drill chuck 20, thereby closing a space 24 disposed between the drill chuck jaws 22a-22c. As the drill chuck jaws 22a-22c extend and the space 24 narrows, a shaft of a drill bit or other driver accessory may be held evenly on mount surfaces 26a, 26b, 26c of the drill chuck jaws 22a-22c, respectively, thereby rigidly holding the shaft in place within the drill chuck 20.

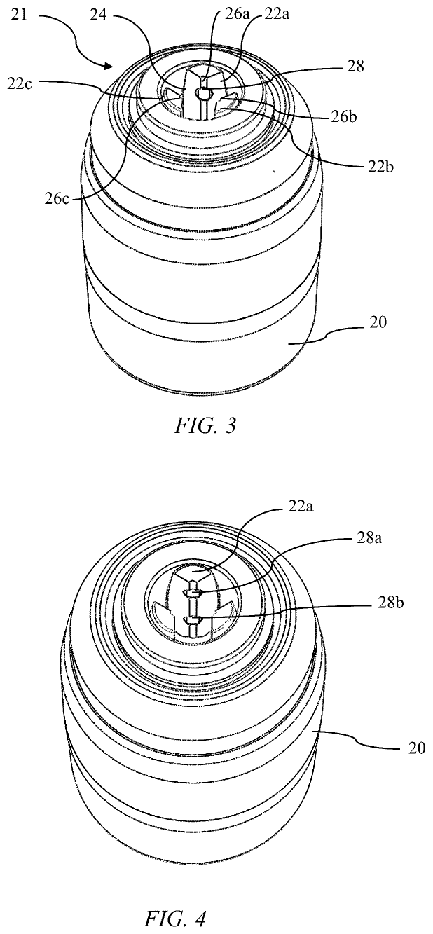

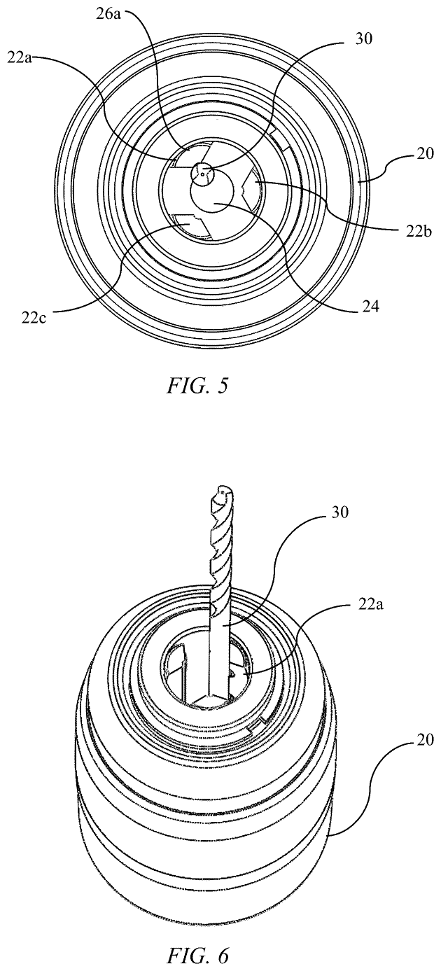

A magnet 28 may be embedded within at least one of the drill chuck jaws, shown in FIG. 3 as embedded within drill chuck jaw 22a. The embedded magnet 28 may be positioned at or near the mount surface 26a of the drill chuck jaw 22a so as to create a localized magnetic field along the e mount surface 26a of the drill chuck jaw 22a, which may magnetically attract and hold a shaft 30 of a drill bit or other driver accessory along the mount surface 26a of the drill chuck jaw 22a, as illustrated in FIGS. 5 and 6. Likewise, FIG. 4 illustrates drill chuck 20 having drill chuck jaw 22a having a pair of magnets 28a, 28b embedded therein. Placement of the pair of magnets 28a, 28b in spaced apart locations longitudinally along the mount surface 26a of drill chuck jaw 22a may aid in aligning the shaft 30 of the drill bit along the mount surface 26a, namely in a straight, vertical orientation, as illustrated in FIGS. 5 and 6, so that the shaft 30 does not get jammed between jaws or otherwise disposed improperly within the drill chuck 20.

As the drill chuck jaws 22a-22c extend via rotation of the annular element 32 (illustrated in FIG. 7) and closes upon the space 24 within the drill chuck 20 between the drill chuck jaws 22a-22c, the shaft 30 of the drill bit or other driver accessory may be held in place on the mount surface 26a of the drill bit jaw 22a, thereby holding the shaft 30 in perfect position for the remaining drill chuck jaws 22b, 22c to close thereupon.

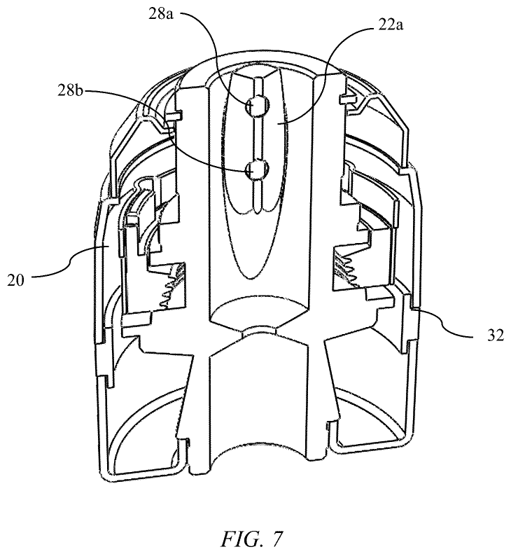

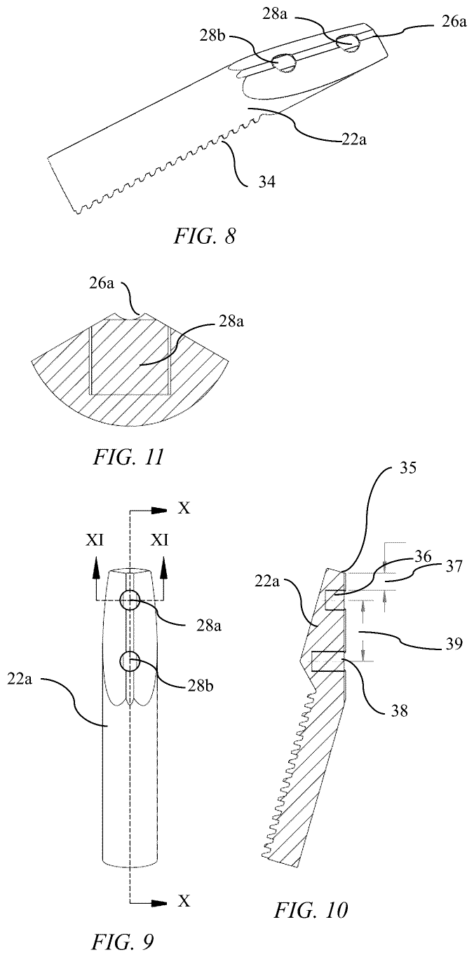

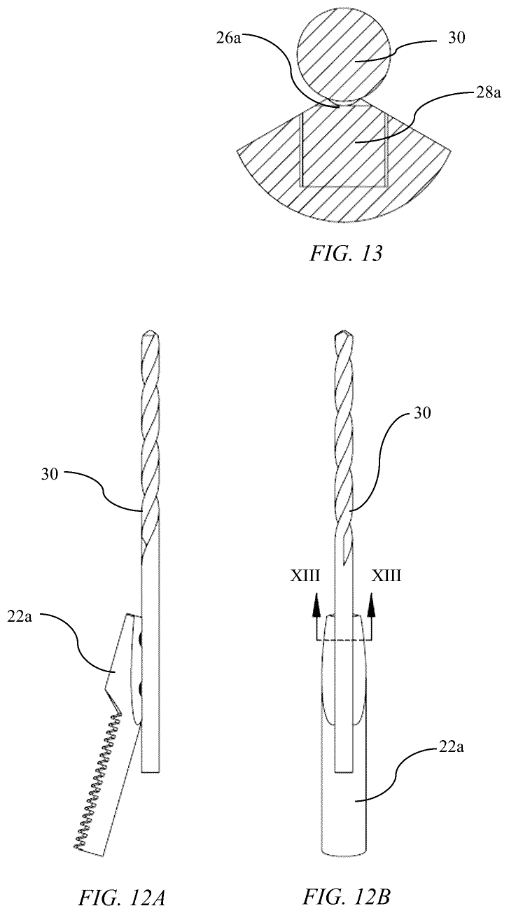

FIGS. 8-25 illustrate various embodiments of the present invention, showing differing placements, sizes, and arrangements of magnets upon or within the drill chuck jaw 22a. Specifically, FIG. 8 illustrates drill chuck jaw 22a having the pair of magnets 28a, 28b embedded within the jaw 22a at or near the mount surface 26a thereof. As illustrated, the pair of magnets 28a, 28b are disposed in spaced apart locations longitudinally along the mount surface 26a, as shown in FIG. 10, so as to hold the shaft 30 of the drill bit in proper position, as illustrated in FIGS. 12A, 12B, and 13. The drill chuck jaw 22a may further have threads 34 for engaging with mating threads on the annular element 32 so that rotation of the annular element 32 engages the threads 34 on the drill chuck jaw 22a, thereby extending or retracting the same, depending on the direction of rotation of the annular element 32.

As shown in FIG. 9, each of the pair of magnets 28a, 28b may have a round cross-section and further may be cylindrical, as illustrated in FIG. 11, spherical, or other like shape, and may further be embedded in first and second cavities 36, 38 within the drill chuck jaw 22a, as illustrated in FIG. 10. FIG. 10 further shows that the cavity 36, holding magnet 28a, may preferably be spaced a distance 37 from a top edge or tip 35 of the drill chuck jaw 22a, thereby ensuring that the shaft 30 of the drill bit or other drill accessory does not prematurely attach to the magnet 28a before being inserted into the drill chuck and aligned in the proper position. Specifically, by ensuring that there is a distance 37 between the magnet 28a and the top edge or tip 35 of the drill chuck jaw 22a, the shaft 30 of the drill bit or other drill accessory may be inserted into the drill chuck and then moved toward and attached to the first magnet 28a.

Likewise, between the first cavity 36, holding the first magnet 28a, and the second cavity 38, holding the second magnet 28b, may be a spaced apart distance 39 ensuring that the first and second magnets 28a, 28b are spaced apart away from each other to allow the shaft 30 of the drill bit or other drill accessory to be held securely and oriented properly.

FIG. 11 further shows the mount surface 26a formed in a concave shape so as better to rigidly hold the shaft 30 when the shaft 30 is disposed thereon, as illustrated in FIG. 13, although it should be noted that the mount surface of each drill chuck jaw may be flat or another shape, as apparent to one of ordinary skill in the art. Preferably, the magnet 28a, as illustrated in the cross-sectional view in FIG. 11, does not extend into or past the concave shape of the mount surface 26a, thereby keeping the mount surface 26a free and clear for mounting to and rigidly holding the shaft 30 when the shaft is disposed thereon.

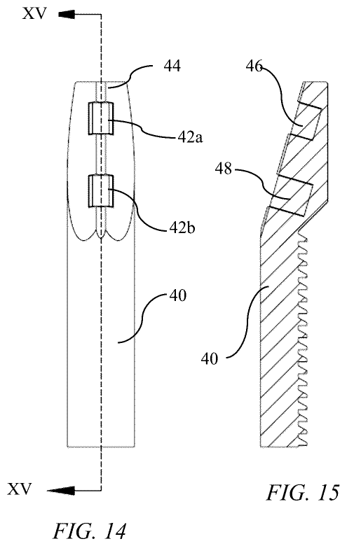

FIG. 14 illustrates an alternate embodiment of the present invention, of a drill chuck jaw 40 having a pair of magnets 42a, 42b disposed therein at or near a mount surface 44 of the drill chuck jaw 40. Each of the pair of magnets 42a, 42b may be cuboid or rectangular prismatic in shape and held in cavities 46, 48, respectively, within the drill chuck jaw 40, as illustrated in FIG. 15.

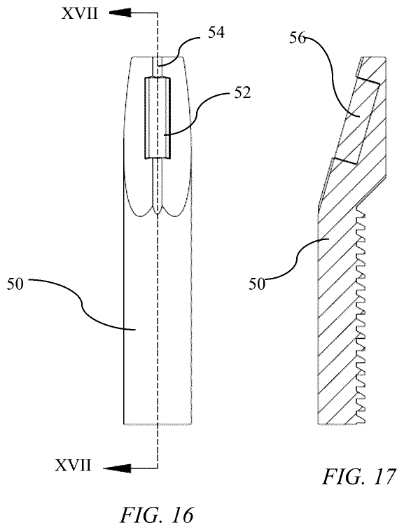

FIG. 16 illustrates another alternate embodiment of the present invention, of a drill chuck jaw 50 having a singular magnet 52 disposed therein at or near a mount surface 54 of the drill chuck jaw 50. The magnet 52 may be cuboid or rectangular prismatic in shape, specifically having a length that may generally be in alignment with the mount surface 54 and further may be held in cavity 56 within the drill chuck jaw 50, as illustrated in FIG. 17.

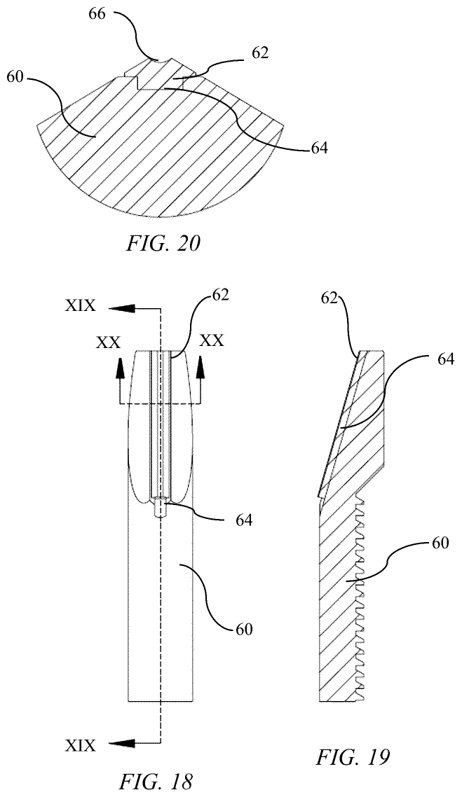

FIG. 18 illustrates yet another alternate embodiment of the present invention, of a drill chuck jaw 60 having a singular magnet 62 disposed within a track 64 of the drill chuck jaw 60. The magnet 62 may further have a shape having, preferably, a flat edge or, as illustrated in FIG. 18, a concave mounting surface 66 for holding a shaft of a drill bit or other driver accessory, as described above. FIGS. 19-20 illustrate various cross-sectional views of the drill chuck jaw 60 wherein the magnet 62 also forms the concave mounting surface 66, which may be held within the track or cavity 64 with adhesive or other adhering means.

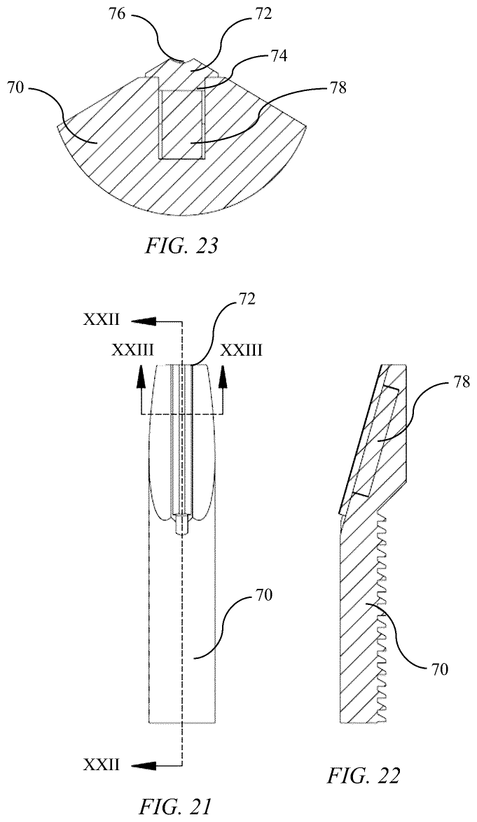

FIG. 21 illustrates yet another further alternate embodiment of the present invention, of a drill chuck jaw 70 having a pad or insert 72 which may be embedded within a track or cavity 74 within the drill chuck jaw 70. The pad or insert 72 may be made from a non-magnetic material, may be held within the track 74 with an adhesive or other adhering means, and may further form a flat or, preferably, a concave mounting surface 76 for holding shafts of drill bits or other like driver accessories. The pad or insert 72 may further have at least one magnet 78 embedded therein. FIGS. 22-23 illustrate various cross-sectional views of the drill chuck jaw 70 wherein the pad or insert 72 also forms the concave mounting surface 76 and the magnet 78 may be embedded within a cavity within the pad or insert 72.

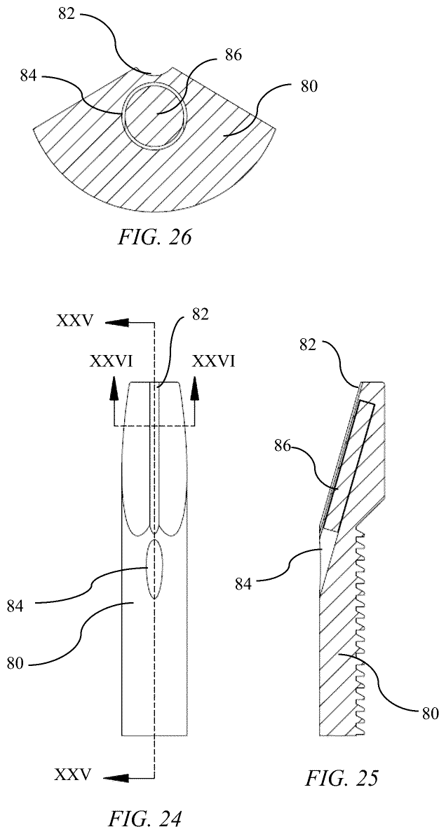

FIG. 24 illustrates yet another alternate embodiment of the present invention, of a drill chuck jaw 80 having and mounting surface 82 for holding a shaft of a drill bit or other driver accessories thereon. The drill chuck jaw 80 may further have a cavity 84 disposed therein and a cylindrical magnet 86 disposed within the cavity 84, which may thus allow the length of the magnet 86 to align with the mounting surface 82, as illustrated in FIGS. 25, 26, thereby aligning the magnetic field of the magnet with the length of the mounting surface 82, aiding in keeping the shaft magnetically held against the mounting surface 82.

The magnets described herein may be made from any magnetic material that is apparent to one of ordinary skill in the art, such as, for example, magnetite, a naturally occurring iron ore that exhibits strong magnetic properties. Other magnets may include artificially-created magnets, such as neodymium magnets, AlNiCo magnets, or may include other natural magnets, which may include minerals like pyrrhotite, ferrite, and columbite. The magnets described herein may further include material that forms induced magnetic fields, such as via electromagnetic induction by the application of electricity thereto. In addition, the magnet or magnets may be disposed within or on the drill chuck jaw, as described herein, in any polar orientation since the magnet or magnets may attract the metal of the drill bit or other drill accessory, no matter the north/south orientation thereof. In addition, a plurality of magnets may be arranged in various arrays to enhance the magnetic field thereof, such as, for example, in a Halbach array, or other arrangement, and the present invention should not be limited as shown and described herein.

Moreover, the magnets described herein may be held within the various spaces and cavities via adhesive bonding, via welding, via potting methodologies, via plastic overmold processes, or via any other methodology apparent to one of ordinary skill in the art.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A chuck jaw comprising:
a body;
a mount surface on the body configured to engage a shaft of a metal object; and
a first magnet disposed on or within the body, wherein the first magnet is configured to hold the shaft of the metal object on and in alignment with the mount surface when the shaft of the metal object is inserted into a top of a chuck comprising the drill chuck jaw.

2. The chuck jaw of claim 1 wherein the mount surface of the body has a shape selected from the group consisting of concave and flat.

3. The chuck jaw of claim 1 wherein the body of the chuck jaw comprises a first cavity, wherein the first magnet is disposed within the cavity.

4. The chuck jaw of claim 1 wherein the chuck jaw is disposed within a chuck with one or more additional chuck jaws for holding the shaft of the metal object therein.

5. The chuck jaw of claim 1 wherein the magnet has a shape selected from the group consisting of a sphere, a cylinder, a cube, and a rectangular prism.

6. The chuck jaw of claim 1 wherein the magnet is disposed within the body at or near the mount surface.

7. The chuck jaw of claim 1 wherein the magnet is disposed a distance from a top edge of the chuck jaw.

8. The chuck jaw of claim 1 further comprising:
a second magnet embedded within the body.

9. The chuck jaw of claim 8 wherein the second magnet is disposed within the body at or near the mount surface.

10. The chuck jaw of claim 8 wherein the first magnet is disposed at a first location at or near the mount surface and the second magnet is disposed at a second location at or near the mount surface, wherein the first location and the second location are spaced a distance apart.

11. The chuck jaw of claim 1 wherein the first magnet is a permanent magnet or an induced magnet.

12. The chuck jaw of claim 1 wherein the first magnet is a neodymium magnet.

13. The chuck jaw of claim 1 wherein the mount surface comprises the first magnet.

14. The chuck jaw of claim 1 further comprising:
a pad or insert forming the mount surface of the body.

15. The chuck jaw of claim 14 wherein the first magnet is embedded on or within the pad or insert forming the mount surface of the body.

16. The chuck jaw of claim 1 wherein the magnet is held on or within the body of the chuck jaw via a method selected from the group consisting of adhesive bonding, welding, potting, and plastic overmolding.

17. The chuck of claim 4 wherein none of the additional chuck jaws have a magnet disposed thereon or therein.

18. A tool or machine comprising the chuck of claim 4.

19. A method of inserting a shaft of an object into a chuck, the method comprising the steps of:
providing a tool or machine comprising a chuck comprising a plurality of chuck jaws, wherein the plurality of chuck jaws extend or retract to hold or release, respectively, the shaft of the object, wherein a first chuck jaw comprises a body, a mount surface on the body configured to engage a shaft of a metal object, and a first magnet disposed on or within the body, wherein the first magnet is configured to hold the shaft of the object on the mount surface;
inserting the shaft of the object into the chuck so that the first magnet on or within the first chuck jaw magnetically holds the shaft of the object along the mount surface on the body of the first chuck jaw; and
extending the plurality of chuck jaws to close the plurality of chuck jaws on the shaft of the object.

20. The method of claim 19 wherein the first chuck jaw further comprises a second magnet disposed on or within the body of the first chuck jaw.

21. The method of claim 20 wherein the first magnet is disposed at a first location at or near the mount surface and the second magnet is disposed at a second location at or near the mount surface, wherein the first location and the second location are spaced a distance apart.
